(19) United States
(12) Patent Application Publication
(10) Pub. No.: US 2022/0387252 A1
(43) Pub. Date: Dec. 8, 2022

(54) MASSAGE GUN

(71) Applicant: Shenzhen Jing Dingfeng Technology Co. Ltd., Shenzhen (CN)

(72) Inventor: TIEJUN ZHOU, Shenzhen (CN)

(21) Appl. No.: 17/647,450

(22) Filed: Jan. 8, 2022

(30) Foreign Application Priority Data
Jun. 5, 2021 (CN) 202121248589.9

(51) Int. Cl. A61H 23/02

(52) U.S. Cl. CPC A61H 23/0254; A61H 2201/0157; A61H 2201/123; A61H 2201/5007

(57) ABSTRACT

A massage gun includes an upper housing, a lower housing snap-fitted with the upper housing, a movement disposed between the upper housing and the lower housing, a front cover sheathed at a end of the movement, a massage head mounted onto an output shaft of the movement, a control panel installed at a rear end of the movement and electrically connected with the movement, a back cover disposed on a surface cover of the control panel, a switch button disposed on the back cover and electrically connected with the control panel.

### CROSS-REFERENCE TO RELATED APPLICATIONS

This application claims the benefit and priority of Chinese patent application No. 202121248589.9, filed on Jun. 5, 2021, disclosure of which is hereby incorporated by reference in its entirety.

### TECHNICAL FIELD

This disclosure relates to a massage gun structure, and more particularly relates to a new-type massage gun structure, which relates to the technical field of massage appliances.

### BACKGROUND

A massage gun, also known as deep myofascial impact instrument, is a soft tissue rehabilitation tool, which can relax the soft tissue of the body through impact at a high and variable frequency, with the basic function similar to that of DMS. Massage gun is an effective method introduced from abroad to treat soft tissue pain and stimulate its proprioceptive function, so as to play an effective role in relieving muscle tension and kill the pain.

When using the existing massage guns, the connection accuracy of the mechanical part of the guns is not high and the positioning error is large, which can easily lead to unstable drive guidance and make the massage gun less comfortable to use.

### SUMMARY

This disclosure aims to provide a new-type massage gun structure to solve the problems of low connection accuracy of the mechanical part and large positioning error of the existing massage guns that are easy to lead to unstable drive guidance and make the massage gun less comfortable to use.

For the above purpose, this disclosure provides the following technical scheme: the disclosure comprises an upper housing and a lower housing that are in clamping connection, a movement is installed between the upper housing and the lower housing, a front cover is sheathed at the end of the movement, a massage head is installed on the output shaft of the movement, a control panel is installed at the rear end of the movement, the control panel is electrically connected with the movement, a back cover is installed on the surface cover of the control panel, a switch button is installed on the back cover surface, the button is electrically connected with the control panel, a battery pack is installed at the bottom of the lower housing, a handle sleeve is sheathed on the outer wall of the battery pack, a bottom cover is installed at the bottom of the battery pack, a charging plate is installed inside the bottom cover, and the charging plate is electrically connected with the battery pack.

As an optional technical scheme of this disclosure, the movement comprises a motor, a bracket silicon pad, a bracket, a silicone sleeve, a piston sleeve, a piston, an upper bracket cover, a small bearing, screws, a large bearing, a guide sleeve cover, a connecting rod, an eccentric wheel, a guide rubber sleeve and a guide shaft sleeve, the output shaft of the motor is respectively sheathed with the eccentric wheel and the large bearing, the outer wall of the large bearing is provided with the connecting rod, and the other end of the connecting rod is sheathed with the small bearing, the screws are threaded at the center of both the large bearing and the small bearing, the bracket is fixedly installed on one side of the motor, the upper bracket cover is installed on the top of the bracket, a guide shaft is installed between the bracket and the upper bracket cover, and the guide shaft sleeve is sheathed on the surface of the guide shaft.

As an optional technical scheme of this disclosure, the surface of the guide shaft sleeve is sheathed with the guide rubber sleeve, the guide sleeve cover is installed on the top of the guide rubber sleeve, the guide shaft is respectively sheathed with the piston, and the surface of the piston is sheathed with the piston sleeve, the surface of the piston sleeve is sheathed with the silicon sleeve, the end of the piston is connected with the massage head, and the top of the piston is fixedly connected with the connecting rod.

As an optional technical scheme of this disclosure, both sides at the bottom of the bracket are fixedly installed with the bracket silicon pad.

As an optional technical scheme of this disclosure, a decorative ring is installed between the battery pack and the bottom cover.

As an optional technical scheme of this disclosure, the battery pack is electrically connected with the motor through the control panel.

Compared with the related art, this disclosure provides the following benefits:

1. This disclosure is a new-type massage gun structure, which connects the motor with the piston through an integrated motor bracket, so that the motor and the piston are positioned in the same part to ensure the consistency of the assembly alignment and improve the assembly accuracy of the product and the consistency of the quality in the mass production.

2. This disclosure is a new-type massage gun structure, which adopts a newly designed piston drive guide, where the piston guide structure enables both the front guide and the rear guide, which can eliminate the transverse force of the piston when it is pushed by the connecting rod more effectively and make the reciprocating motion of the piston more stable and smooth.

### BRIEF DESCRIPTION OF DRAWINGS

FIG. 1 is a schematic diagram of this disclosure;

FIG. 2 is a schematic diagram of the unfolding structure of the movement of this disclosure;

FIG. 3 is a schematic diagram of the movement assembly structure of this disclosure;

FIG. 4 is a sectional view illustrating the movement of this disclosure.

In the figures: 1. Upper housing; 2. Movement; 201. Motor; 202. Support silicon pad; 203. Support; 204. Silicone sleeve; 205. Piston sleeve; 206. Piston; 207. Upper bracket cover; 208. Small bearing; 209. Screws; 210. Large bearing; 211. Guide sleeve cover; 212. Connecting rod; 213. Eccentric wheel; 214. Guide rubber sleeve; 215. Guide shaft sleeve; 3. Front cover; 4. Massage head; 5. Lower housing; 6. Control panel; 7. Back cover; 8. Switch button; 9. Battery pack; 10. Handle sleeve; 11. Decorative ring; 12. Charging board; 13. Bottom cover.

### DETAILED DESCRIPTION

The technical scheme in the embodiment of this disclosure will be described clearly and completely in combination with the illustrations in the embodiment of this disclosure. Obviously, the described embodiment is only part of the embodiment of this disclosure instead of all. Based on the embodiment of this disclosure, all other embodiment obtained by ordinary technicians in this field without making creative work shall be protected by this disclosure.

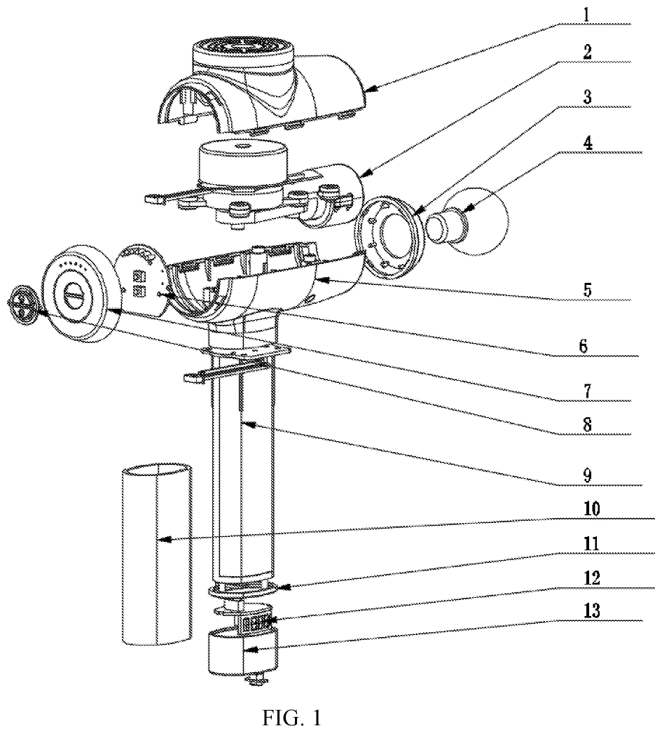

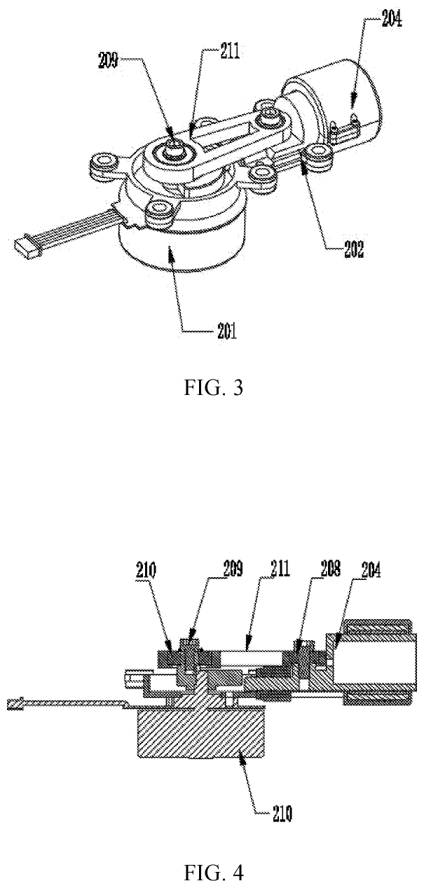

Referring to FIGS. 1-4. This disclosure offers a technical solution for a new-type massage gun structure:

As shown in FIGS. 1-4, it is composed of an upper housing 1 and a lower housing 5, a movement 2 is installed between the upper housing 1 and the lower housing 5 a front cover 3 is sheathed at the end of the movement 2, a massage head 4 is installed on the output shaft of the movement 2, a control panel 6 is installed at the rear end of the movement 2, the control panel 6 is electrically connected with the movement 2, a back cover 7 is set on the surface cover of the control panel 6, a switch button 8 is installed on the surface of the back cover 7, and the button 8 is electrically connected with the control panel 6, a battery pack 9 is installed at the bottom of the lower housing 5, a handle sleeve 10 is sheathed on the outer wall of the battery pack 9, a bottom cover 13 is installed at the bottom of the battery pack 9, a charging plate 12 is installed inside the bottom cover 13, and the charging plate 12 is electrically connected with the battery pack 9.

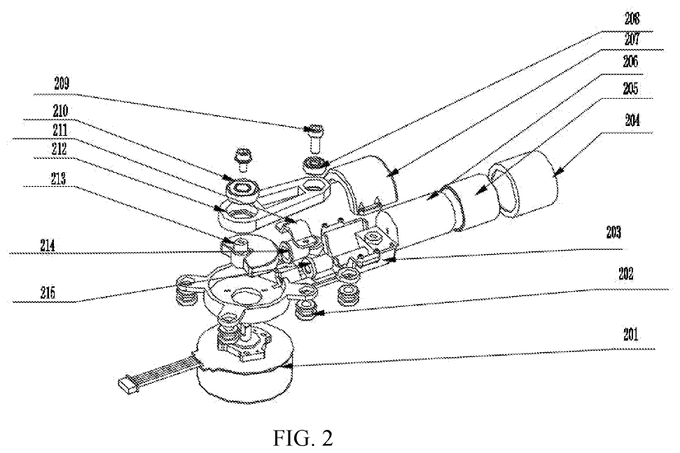

According to FIGS. 1 and 2, movement 2 includes a motor 201, a bracket silicon pad 202, a bracket 203, a silicon sleeve 204, a piston sleeve 205, a piston 206, an upper bracket cover 207, a small bearing 208, screws 209, a large bearing 210, a guide sleeve cover 211, a connecting rod 212, an eccentric wheel 213, a guide rubber sleeve 214 and a guide shaft sleeve 215. The output shaft of the motor 201 is respectively sheathed with the eccentric wheel 213 and the large bearing 210, the connecting rod 212 is installed on the outer wall of the large bearing 210, the other end of the connecting rod 212 is sheathed with the small bearing 208, the screws 209 are threaded at the center of both the large bearing 210 and the small bearing 208, the bracket 203 is fixedly installed at one side of the motor 201, the upper bracket cover 207 is installed on the top of the bracket 203, the guide shaft is installed between the bracket 203 and the upper bracket cover 207, the guide shaft sleeve 215 is sheathed with the guide rubber sleeve 214, the guide sleeve cover 211 is installed on the top of the guide rubber sleeve 214, the guide shaft is respectively sheathed with the piston 206, and the surface of the piston 206 is sheathed with the piston sleeve 205, the surface of the piston sleeve 205 is sheathed with the silicon sleeve 204, the end of the piston 206 is connected with the massage head 4) and the top of the piston 206 is fixedly connected with the connecting rod 212. Both sides at the bottom of bracket 203 are fixedly installed with bracket silicon pad 202. The motor 201 is connected with the piston 206 through the integrated bracket 203 so that the motor 201 and the piston 206 are positioned in the same part to ensure the consistency of the assembly alignment and improve the assembly accuracy of the product and the consistency of the quality in the mass production.

As shown in FIGS. 1 and 2, both sides of the bottom end of the bracket 203 are fixedly installed with the bracket silicon pad 202, a decorative ring 11 is installed between the battery pack 9 and the bottom cover 13, the battery pack 9 is electrically connected with the motor 201 through the control panel 6, and the motor 201 is powered through the battery pack 9.

In specific use, this disclosure is a new-type massage gun structure, which controls the motor 201 through the switch button 8, drives the eccentric wheel 213 through the rotation of the motor 201, drives the reciprocating motion of the piston 206 through the rotation of the eccentric wheel 213, and drives the reciprocating motion of the massage head 4 to massage through the reciprocating motion of the piston. The motor 201 and the piston 206 are positioned in the same part to ensure the consistency of the assembly alignment and improve the assembly accuracy of the product and the consistency of the quality in the mass production.

In the description of this disclosure, it needs to be understood that the orientation or position relationship indicated is based on that shown in the figures, which is only for the convenience of describing this disclosure and simplifying the description rather than indicating or implying a necessarily specific orientation, structure, and operation way for the devices or elements. Therefore, it shall not be comprehended as a limitation of this disclosure.

In this disclosure, unless otherwise specified and defined, for example, it can be fixed connection, detachable connection, or integrated connection; it can be mechanical connection or electrical connection; directly connection, or an indirect connection through a medium, or internal connection of two components or interaction between two components, unless otherwise specific limited, the ordinary technicians in this field are allowed to comprehend the specific definition of the above technical terms according to the specific situation.

Although the embodiment of this disclosure has been presented and described, it is understandable that the ordinary technicians in this field make a variety of changes, modifications, substitutions, and variants to the embodiment without breaking away from the principle and spirit of this disclosure, and the scope of this disclosure is defined by the appended claims and their equivalents.

What is claimed is:

1. A massage gun, comprising:
an upper housing;
a lower housing, snap-fitted with the upper housing;
a movement, disposed between the upper housing and the lower housing;
a front cover, sheathed at an end of the movement;
a massage head, mounted onto an output shaft of the movement;
a control panel, disposed at a rear end of the movement and electrically coupled with the movement;
a back cover, disposed on a surface the control panel;
a switch button, disposed on the back cover and electrically coupled with the control panel;
a battery pack, installed at a bottom of the lower housing;
a handle sleeve, sheathed on an outer wall of the battery pack;
a bottom cover, installed at a bottom of the battery pack; and
a charging plate, installed inside the bottom cover and electrically coupled with the battery pack.

2. The massage gun as recited in claim 1, wherein the movement comprises a motor, a bracket silicon pad, a bracket, a silicon sleeve, a piston sleeve, a piston, a upper bracket cover, a small bearing, screws, a large bearing, a guide sleeve cover, a connecting rod, an eccentric wheel, a guide rubber sleeve, and a guide shaft sleeve, wherein the output shaft of the motor is sheathed with the eccentric wheel and the large bearing, an outer wall of the large bearing is provided with the connecting rod, and another end of the connecting rod is sheathed with the small bearing, the screws are threaded at a center of each of the large bearing and the small bearing, the bracket is fixedly installed on one side of the motor, the upper bracket cover is installed on a top of the bracket, a guide shaft is installed between the bracket and the upper bracket cover, and the guide shaft sleeve is sheathed on a surface of the guide shaft.

3. The massage gun as recited in claim 2, wherein a surface of the guide shaft sleeve is sheathed with the guide rubber sleeve, the guide sleeve cover is installed on the top of the guide rubber sleeve, the guide shaft is sheathed with the piston, and the surface of the piston is sheathed with the piston sleeve, the surface of the piston sleeve is sheathed with the silicon sleeve, the end of the piston is connected with the massage head, and the top of the piston is fixedly connected with the connecting rod.

4. The massage gun as recited in claim 2, wherein both sides at the bottom of the bracket are fixedly installed with the bracket silicon pad.

5. The massage gun as recited in claim 1, further comprising a decorative ring installed between the battery pack and the bottom cover.

6. The massage gun as recited in claim 1, wherein the battery pack is electrically connected with the motor through the control panel.
